(19) United States
(12) Patent Application Publication
(10) Pub. No.: US 2026/0138266 A1
(43) Pub. Date: May 21, 2026

(54) EXOSKELETON SYSTEM

(71) Applicant: SHANGHAI UNIVERSITY OF MEDICINE & HEALTH SCIENCES, SHANGHAI (CN)

(72) Inventors: JIACHEN GUO, SHANGHAI (CN); LIANG ZHOU, SHANGHAI (CN); TAO WU, SHANGHAI (CN); YU GAO, SHANGHAI (CN); JIAQI ZHANG, SHANGHAI (CN)

(21) Appl. No.: 19/060,339

(22) Filed: Feb. 21, 2025

(30) Foreign Application Priority Data
Nov. 19, 2024 (CN) 202411658005.3

(51) Int. Cl. B25J 9/00

(52) U.S. Cl. CPC B25J 9/0006

(57) ABSTRACT

An exoskeleton system, including a right leg mechanism, a left leg mechanism, a hip frame mechanism, and an upper body mechanism. The hip frame mechanism is installed at a hip position of a user by four straps, and a battery pack and a control center are installed on a rear side of the hip frame mechanism. The right leg mechanism is rotatably connected to a right side of the hip frame mechanism. The left leg mechanism is rotatably connected to a left side of the hip frame mechanism. An elastic holding plate is arranged in the upper body mechanism. Six sections are arranged on an inner side of the holding plate and connected end to end.

### CROSS-REFERENCE TO RELATED APPLICATION

This patent application claims the benefit and priority of Chinese Patent Application No. 202411658005.3 filed with the China National Intellectual Property Administration on Nov. 19, 2024, the disclosure of which is incorporated by reference herein in its entirety as part of the present application.

### TECHNICAL FIELD

The present disclosure relates to the technical field of exoskeleton, and in particular to an exoskeleton system.

### BACKGROUND

Exoskeleton technology is a technology that provides extra power or ability for human body by using advanced technologies such as sensing, control, information coupling and mobile computing through a device system wearing outside the human body. In the medical field, the exoskeleton can help disabled people regain their freedom of movement, enhance their muscle strength, and enable them to participate in social life again. The exoskeleton technology can also be used for rehabilitation to help patients recover their muscle function and joint range of motion. In the military field, exoskeleton armor can help soldiers bear heavier loads on the battlefield, enhance their strength and endurance, and improve operational efficiency. Meanwhile, the exoskeleton armor can provide additional protection for the soldiers to reduce the casualty rate of soldiers on the battlefield. In the industrial field, the exoskeleton technology can help workers complete heavy or high-risk tasks, such as the maintenance of industrial robots, vehicle assembly of automobile production lines, etc. Exoskeleton not only can improve work efficiency and safety of workers, but also can reduce physical consumption of workers and the occurrence of occupational diseases. In the field of emergency rescue, the exoskeleton technology can help rescuers transport the wounded, thus improving the efficiency and success rate of rescue.

There are still some defects in the existing exoskeleton apparatuses, for example, the current exoskeleton apparatus generally faces the problem of short energy endurance, which greatly limits the continuous working ability and application scenarios of the exoskeleton apparatus. Some exoskeleton apparatuses themselves have a large weight, which is not only inconvenient for users to operate, but also consumes too much energy, leading to the further reduction of the battery life. Therefore, it is of great economic and social significance to develop an exoskeleton system with long battery time and light weight.

### SUMMARY

In order to solve the disadvantages in the prior art, an objective of the present disclosure is to provide an exoskeleton system, which mainly includes a right leg mechanism, a left leg mechanism, a hip frame mechanism, and an upper body mechanism. The hip frame mechanism mainly includes a hip frame, a battery pack, a control center, a left hip strap, a right hip strap, a multi-port buckle, a right buttock strap and a left buttock strap. The battery pack and the control center are installed on a rear side of the hip frame. The multi-port buckle is provided with four insertion holes, and is provided with an unlock button at a center position of a front side. Rear ends of the right hip strap, the left hip strap, the right buttock strap and the left buttock strap are all connected to the hip frame, and front ends of the right hip strap, the left hip strap, the right buttock strap and the left buttock strap are all locked to the multi-port buckle by plugs. The right leg mechanism mainly includes a right rotating seat, a right spring rod, an upper arm of a right thigh, an upper strap of a right leg, a lower arm of the right thigh, a right rotating motor, a right elastic plate, a right support rod, an upper arm of a right calf, a lower arm of the right calf, a lower strap of the right leg, a right adjustable motor, a right power generation block, a right pressure member, a right foot plate, a right pressure sensor, a lower copper plate, a right piezoelectric ceramic, and an upper copper plate. The right rotating seat is installed on a right end of the hip frame to form a revolute pair, an upper end of the upper arm of the right thigh is rotatably connected to a lower end of the right rotating seat, the right spring rod is installed between the right rotating seat and the upper arm of the right thigh, and the upper strap of the right leg is arranged on an inner side of a lower end of the upper arm of the right thigh. The lower arm of the right thigh is installed on an outer side of the upper arm of the right thigh through the meshing of toothed plates and by screw locking, and one right rotating motor is installed at a position adjacent to a lower end of the lower arm of the right thigh. An upper end of the upper arm of the right calf is rotatably connected to a lower end of the lower arm of the right thigh, the lower strap of the right leg is arranged on an inner side of a lower end of the upper arm of the right calf, an output shaft of the right rotating motor is fastened to a front end of the right elastic plate, a rear end of the right elastic plate is rotatably connected to an upper end of the right support rod, and a lower end of the right support rod is rotatably connected to the upper arm of the right calf at a position adjacent to the upper end of the upper arm of the right calf. The lower arm of the right calf is installed on an outer side of the upper arm of the right calf through the meshing of toothed plates and by screw locking. The right power generation block is installed on an outer side of the lower arm of the right calf and capable of moving up and down, the right adjustable motor is fixedly installed on the outer side of the lower arm of the right calf, external threads are formed on an output shaft of the right adjustable motor, and the threaded output shaft is fitted with a threaded cavity at an upper end of the right power generation block to form a screw-thread pair; the right power generation block is internally provided with a rectangular cavity. The upper copper plate, the right piezoelectric ceramic, the lower copper plate, a damping block and the right pressure member are sequentially installed in the rectangular cavity from top to bottom; the upper copper plate and the lower copper plate are electrically connected to the battery pack by two cables, respectively. A lower end of the right pressure member is rotatably connected to an upper end of the right foot plate, the right pressure sensor is installed on an upper side of a pedal structure on a left side of the right foot plate, and the left leg mechanism and the right leg mechanism form a bilateral symmetric structure. The upper body mechanism mainly includes a connecting frame, a holding plate, a first section, a second section, a third section, a fourth section, a fifth section, a sixth section, a left hanger, a right hanger, a left hanging strap, a right hanging strap, a left hook, and a right hook. A lower end of the connecting frame is fixedly installed at a middle position of a rear side of the hip frame; the holding plate is of a curved plate structure, a lower end of the holding plate and a lower end of the first section are both rotatably connected to an upper end of the connecting frame. The first section, the second section, the third section, the fourth section, the fifth section and the sixth section are installed on a front side of the holding plate, and sequentially connected end to end through five rotating shafts from bottom to top, and the five rotating shafts are all located on a rear side of the holding plate. An upper end of the sixth section is connected to an upper end of the holding plate by a pin shaft. Lengthening plates are arranged on left and right sides of the fourth section and the fifth section. A lower chest strap is installed at left and right ends of the fourth section, and an upper chest strap is installed at left and right ends of the fifth section. A lower end of the left hanger is fixedly connected to a left side of the sixth section, and an upper end of the left hanger is connected to the left hook through the left hanging strap after crossing a left shoulder of a user forward. A lower end of the right hanger is fixedly connected to a right side of the sixth section, and an upper end of the right hanger is connected to the right hook through the right hanging strap after crossing a right shoulder of the user forward.

Preferably, the battery pack can be charged and discharged, and provide electric energy for all electrical devices of the exoskeleton system. A central processing unit and an integrated circuit are integrated into the control center, and the control center is configured automatically control electric components in the exoskeleton system based on pre-set parameters.

Preferably, each of the upper strap of the right leg, the lower strap of the right leg, the upper strap of the left leg and the lower strap of the left leg is a flexible belt structure with an adjustable length, and can be rapidly locked and unlocked through a socket-plug structure.

Preferably, the right rotating motor employs a form of a direct drive motor, and the direct drive motor has the advantages of large low-speed torque, simple structure and low noise. A torque sensor and an encoder are integrated inside the right rotating motor. the torque sensor is configured to monitor an output torque of the right rotating motor in real time, and the encoder is configured to detect a rotating angle of an output shaft of the right rotating motor in real time, so as to determine a bending condition of a right knee joint of the user.

Preferably, the right elastic plate is made of an elastic glass fiber material, which has excellent mechanical properties, and the characteristics of light weight, high strength, high and low temperature resistance, and corrosion resistance.

Preferably, after the right piezoelectric ceramic is pressed, pulse voltages are generated at an upper end and a lower end of the right piezoelectric ceramic, thus a pulse potential difference between the upper copper plate and the lower copper plate is generated. The pulse potential difference is transmitted into the battery pack through a cable to the battery pack for pulse charging.

Preferably, the right pressure sensor is configured to monitor a pressure between the right leg and the ground in real time, and transmit data to the control center for analysis.

Preferably, the bending degree of the holding plate is the same as a physiological curve of human spine, and the holding plate is made of an elastic glass fiber material.

Preferably, each of the lower chest strap and the upper chest strap is a flexible belt structure with an adjustable length, and can be rapidly locked and unlocked through a socket-plug structure.

Preferably, each of the left hanging belt and the right hanging belt is a flexible belt structure with an adjustable length.

The present disclosure has the beneficial effects as follows: (1) when the user bends down, the holding plate can effectively reduce the pressure on erector spinae group of the user. When the user walks with a heavy object, the holding plate can bear most of the load of the heavy object, and the vertical pressure on the spine of the user can be relieved. (2) Each of the left leg mechanism and the right leg mechanism can be adjusted according to the length of the leg bone of the user, such that the exoskeleton system is suitable for users with different heights, and has strong adaptability. (3) The left rotating motor and the right rotating motor can respectively provide help for muscle groups of the left knee joint and right knee joint through elastic plates and the support rods, thus relieving the muscle pressure of the user when squatting. (4) The left power generation block and the right power generation block can alternately generate pulse voltages to charge the battery pack when the user walks, and the biological mechanical energy is converted into electric energy, which can effectively improve the battery life of the exoskeleton system. (5) The left adjustable motor and the right adjustable motor adopt a negative feedback closed-loop control mode, which can dynamically adjust the pressures exerted by the left foot and right foot of the user on the ground, and is conducive to the body balance of the user while controlling the load on the feet.

### BRIEF DESCRIPTION OF THE DRAWINGS

FIG. 1 is a schematic diagram of an overall structure according to the present disclosure;

FIG. 2 is a schematic structural diagram of an exoskeleton system of a lower half body according to the present disclosure;

FIG. 3 is a schematic structural diagram of an exoskeleton system of an upper half part according to the present disclosure;

FIG. 4 is a schematic diagram of a partial sectional structure of a position where a right power generation block according to the present disclosure is located;

FIG. 5 is a partial exploded view of a position where a lower arm of right calf according to the present disclosure is located.

In the drawings: 1—right leg mechanism; 2—left leg mechanism; 3—hip frame mechanism; 4—upper body mechanism; 5—hip frame; 6—multi-port buckle; 7—right hip strap; 8—right hip strap; 9—right buttock strap; 10—left buttock strap; 11—battery pack; 12—control center; 13—connecting frame; 14—holding plate; 15—first section; 16—right rotating seat; 17—right spring rod; 18—upper arm of right thigh; 19—right upper pressure block; 20—right upper locking screw; 21—upper strap of right thigh; 22—lower arm of right thigh; 23—right rotating motor; 24—fixed hoop; 25—right elastic plate; 26—rotatable hoop; 27—right support rod; 28—upper arm of right calf; 29—right lower pressure block; 30—right lower locking screw; 31—lower arm of right calf; 32—lower strap of right calf; 33—right adjustable motor; 34—right power generation block; 35—right pressure member; 36—right foot plate; 37—right pressure sensor; 38—upper arm of left thigh; 39—upper strap of left leg; 40—lower arm of left thigh; 41—left rotating motor; 42—left elastic plate; 43—left support rod; 44—upper arm of left calf; 45—lower strap of left leg; 46—left adjustable motor; 47—lower arm of left calf; 48—left power generation block; 49—mushroom head; 50—left pressure member; 51—left foot plate; 52—left pressure sensor; 53—left spring rod; 54—fourth section; 55—first shaft; 56—second section; 57—third section; 58—second shaft; 59—third shaft; 60—left hook; 61—fourth shaft; 62—left hanging strap; 63—fifth shaft; 64—left hanger; 65—sixth section; 66—right hanger; 67—right hanging strap; 68—fifth section; 69—right hook; 70—lower copper plate; 71—right piezoelectric ceramic; 72—upper copper plate; 73—upper cable; 74—threaded shaft; 75—threaded cavity; 76—lower cable; 77—damping block; 78—spring; 79—outer toothed plate; 80—guide block; 81—inner toothed plate; 82—guide slot hole; 83—lower chest strap; 84—upper chest strap.

### DETAILED DESCRIPTION OF THE EMBODIMENTS

The present disclosure is further described below in conjunction with specific embodiments, and the illustrative embodiments of the present disclosure and their descriptions are used to explain the present disclosure, and do not constitute a limitation of the present disclosure.

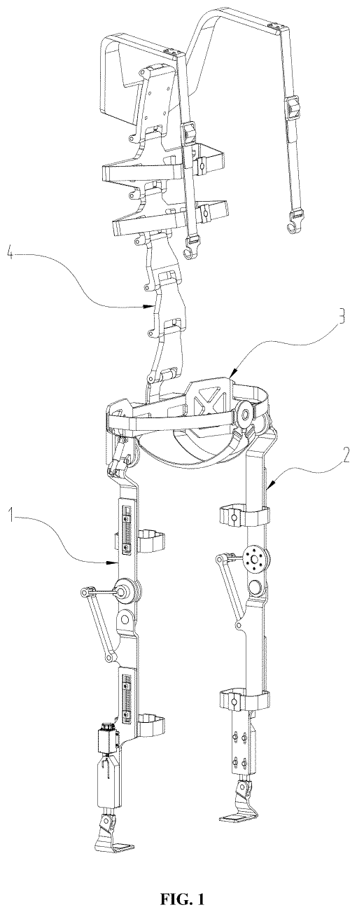

As shown in FIG. 1 to FIG. 5, an exoskeleton system mainly includes a right leg mechanism 1, a left leg mechanism 2, a hip frame mechanism 3, and an upper body mechanism 4. A rear side of the hip frame mechanism 3 is of an arc structure to better fit a rear side of the hip of a user. A rear side of the hip frame mechanism 3 is further provided with a battery pack 11 and a control center 12. The battery pack 11 can be charged and discharged, and provide electric energy to all electrical devices of the exoskeleton system. A central processing unit and an integrated circuit are integrated into the control center 12, and the control center 12 can achieve the automated control of electric components in the exoskeleton system according to pre-set parameters. A multi-port buckle 6 is provided with four insertion holes, and is provided with an unlock button at a center position of a front side. A rear end of the right hip strap 7 is fastened to a right end of the hip frame 5, and a front end of the right hip strap 7 is provided with a plug which can be inserted into an insertion hole on a right side of the multi-port buckle 6 to achieve locking. A rear end of the left hip strap 8 is fastened to a left end of the hip frame 5, a front end of the left hip strap 8 is provided with a plug which can be inserted into an insertion hole on a left side of the multi-port buckle 6 to achieve locking. A rear end of the right buttock strap 9 is fastened to a lower right side of the hip frame 5, a front end of the right buttock strap 9 is provided with a plug which can be inserted into an insertion hole on the lower right side of the hip frame 5 to achieve locking. A rear end of the left buttock strap 10 is fastened to a lower left side of the hip frame 5, a front end of the left buttock strap 10 is provided with a plug which can be inserted into an insertion hole on the lower left side of the multi-port buckle 6 to achieve locking. An unlock button on the front side of the multi-port buckle 6 is pressed to unlock the right hip strap 7, the left hip strap 8, the right buttock strap 9, and the left buttock strap 10 simultaneously.

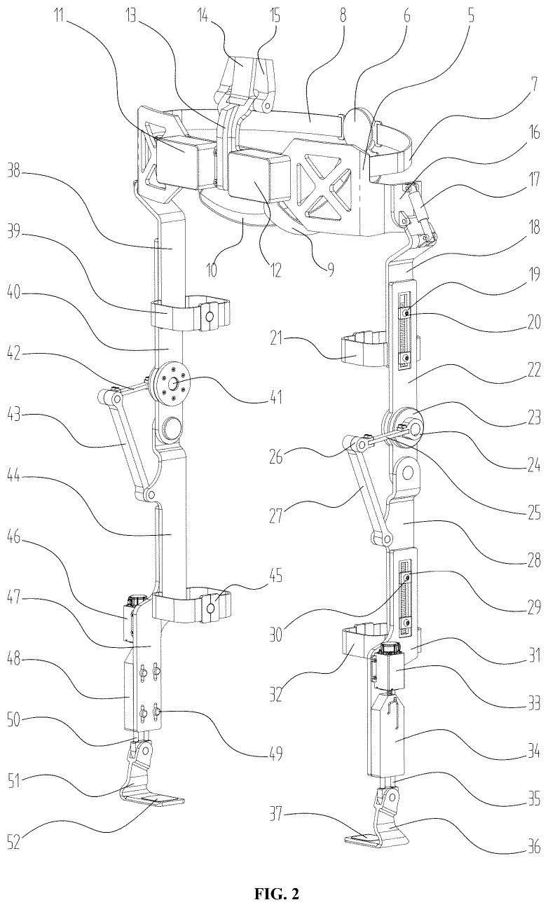

As shown in FIG. 2, the right leg mechanism 1 mainly includes a right rotating seat 16, a right spring rod 17, an upper arm 18 of a right thigh, a right upper pressure block 19, a right upper locking screw 20, an upper strap 21 of a right leg, a lower arm 22 of the right thigh, a right rotating motor 23, a fixed hoop 24, a right elastic plate 25, a rotatable hoop 26, a right support rod 27, an upper arm 28 of a right calf, a right lower pressure block 29, a right lower locking screw 30, a lower arm 31 of the right calf, a lower strap 32 of the right leg, a right adjustable motor 33, a right power generation block 34, a right pressure member 35, a right foot plate 36, a right pressure sensor 37, a lower copper plate 70, a right piezoelectric ceramic 71, and an upper copper plate 72. A left side of the right rotating seat 16 is installed on a right end of the hip frame 5 to form a revolute pair, and a rotating shaft is located on an outer side of a right hip joint. An upper end of the upper arm 18 of the right thigh is rotatably connected to a lower end of the right rotating seat 16, a pressure spring and a damper are integrated into the right spring rod 17; an upper end of the right spring rod 17 is rotatably connected to an upper end of the right rotating seat 16, and a lower end of the right spring rod 17 is rotatably connected to the upper arm 18 of the right calf at a position adjacent to an upper end of the upper arm 18 of the right thigh, such that the right spring rod 17 can provide a support force to improve the stability of the exoskeleton system when the upper arm 18 of the right thigh swings towards right. The upper strap 21 of the right leg is arranged on an inner side of a lower end of the upper arm 18 of the right thigh, the upper strap 21 of the right leg is a flexible belt structure with an adjustable length, and can achieve rapid locking and unlocking through a socket-plug structure. The upper strap 21 of the right leg is bound at the right thigh of the user. An outer toothed plate is vertically arranged on an outer side of the lower end of the upper arm 18 of the right thigh, two guide blocks are vertically formed in the middle position of the outer toothed plate, and a threaded hole is formed in a center position of each of the two guide blocks.

The lower arm 22 of the right thigh is of a platy structure, the lower arm 22 of the right thigh is vertically provided with a square guide slot which runs through from left to right at an upper end, and an inner toothed plate is vertically arranged on a left side of the upper end of the lower arm 22 of the right thigh. The lower arm 22 of the right thigh is installed on an outer side of the upper arm 18 of the right thigh, the outer toothed plate is meshed with the inner toothed plate, and the two guide blocks on the outer side of the upper arm 18 of the right thigh are located in a square groove at the upper end of the lower arm 22 of the right thigh. The right upper pressure block 19 is of a square platy structure, and a round hole is formed at a center of the right upper pressure block 19. The two right upper pressure blocks 19 are installed on an outer side of the square guide slot, and the two right upper locking screws 20 are fitted with threaded holes at the centers of the corresponding guide blocks after passing through the two right upper pressure blocks 19, respectively, such that locking and fixation of the upper arm 18 of the right thigh and the lower arm 22 of the right thigh can be achieved by tightening the two right upper locking screws 20. After unscrewing the two right upper locking screws 20, the relative positions of the upper arm 18 of the right thigh and the lower arm 22 of the right thigh can be adjusted according to the bone length of the right thigh of the user. One right rotating motor 23 is fixedly installed at a position adjacent to a lower end of the lower arm 22 of the right thigh. The right rotating motor 23 employs a form of a direct drive motor. The direct drive motor has the advantages of large low-speed torque, simple structure, and low noise. A torque sensor and an encoder are integrated inside the right rotating motor 23. The torque sensor is configured to monitor an output torque of the right rotating motor 23 in real time, and the encoder is configured to detect a rotating angle of an output shaft of the right rotating motor 23 in real time, so as to determine a bending condition of a right knee joint of the user. The right rotating motor 23 is electrically connected to the control center 12.

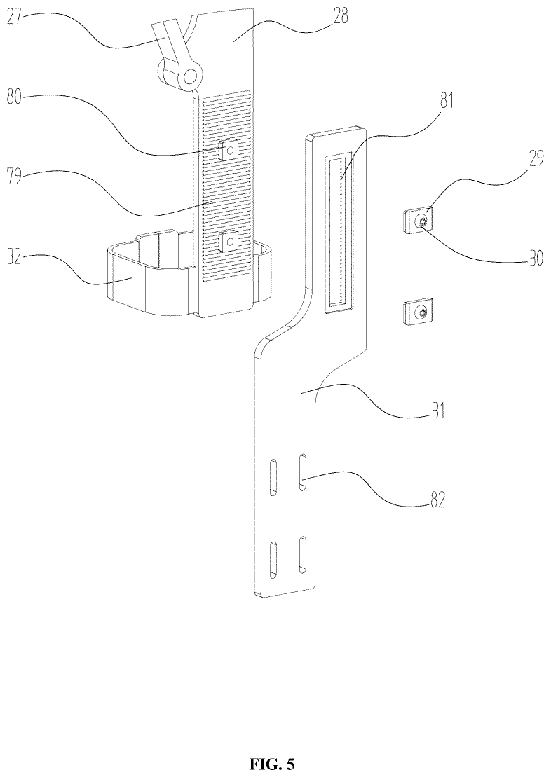

As shown in FIG. 2 and FIG. 5, the upper arm 28 of the right calf is of a platy structure, an upper end of the upper arm 28 of the right calf is rotatably connected to a lower end of the lower arm 22 of the right thigh, and a rotating shaft is located on an outer side of the right knee of the user. A right side of a lower end of the upper arm 28 of the right calf is vertically provided with an outer toothed plate 79, two guide blocks 80 are vertically formed in a middle position of the outer toothed plate 79, and a threaded hole is formed in a center position of each of the two guide blocks 80. The lower strap 32 of the right leg is arranged on an inner side of a lower end of the upper arm 28 of the right calf, the lower strap 32 is a flexible belt structure with an adjustable length, and can achieve rapid locking and unlocking through a socket-plug structure. The lower strap 32 of the right leg is bound to the right calf of the user. An output shaft of the right rotating motor 23 is coaxially fastened to the fixed hoop 24, and the fixed hoop 24 is fastened to a front end of the right elastic plate 25 by a screw. The right elastic plate 25 may be made of an elastic glass fiber material which has excellent mechanical properties, and characteristics of light weight, high strength, high-temperature resistance, and corrosion resistance. A rear end of the right elastic plate 25 is fastened to the rotatable hoop 26 by a screw, the rotatable hoop 26 is rotatably connected to an upper end of the right support rod 27, a lower end of the right support rod 27 is rotatably connected to the upper arm 28 of the right calf at a position adjacent to the upper end of the upper arm 28 of the right calf, and the right support rod 27 may be made of a carbon fiber material. Therefore, when the user squats, stands up, takes off, walks, etc., the right rotating motor 23 applies a rotational torque to the upper arm 28 of the right calf through the right elastic plate 25 and the right support rod 27, thereby the pressure on the muscle group of the right knee joint of the user is relieved.

The lower arm 31 of the right calf is of a platy structure, a lower end of the lower arm 31 of the right calf deviates backward to a heel position, an upper end of the lower arm 31 of the right calf is vertically provided with a square guide slot which runs through from left to right, and an inner toothed plate 81 is vertically arranged on a left side of the upper end of the lower arm 31 of the right calf. The lower arm 31 of the right calf is installed on an outer side of the upper arm 28 of the right calf, the outer toothed plate 79 is meshed with the inner toothed plate 81, and the two guide blocks 80 on the outer side of the upper arm 28 of the right calf are in the square slot at the upper end of the lower arm 31 of the right calf. A structure of the right lower pressure block 29 is the same as that of the right upper pressure block 19. Two right lower pressure blocks 29 are installed on the outer side of the square guide slot at the upper end of the lower arm 31 of the right calf, respectively, two right lower locking screws 30 are fitted with threaded holes formed in the centers of the corresponding guide blocks 80 after passing through the two right lower pressure blocks 29, respectively, such that the locking and fixation of the upper arm 28 of the right calf and the lower arm 31 of the right calf can be achieved by tightening the two right lower locking screws 30. After unscrewing the two right lower locking screws 30, the relative positions of the upper arm 28 of the right calf and the lower arm 31 of the right calf can be adjusted according to the bone length of the right calf of the user. Four guide slot holes 82 are formed in a lower end of the lower arm 31 of the right calf, and each guide slot hole 82 is a vertically arranged strip-shaped through hole.

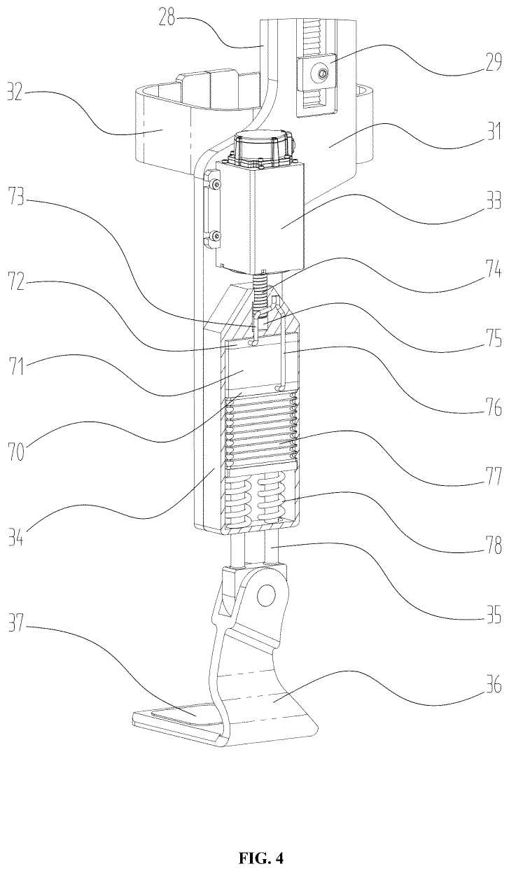

As shown in FIG. 2 and FIG. 4, the right power generation block 34 is installed on an outer side of the lower end of the lower arm 31 of the right calf, four mushroom heads are arranged on a left side of the right power generation block 34, and each mushroom head is a stepped round rod structure with a larger outer diameter and a smaller inner diameter. The four mushroom heads are fitted with the four guide slot holes 82, respectively, such that the right power generation block 34 can move up and down. An upper end of the right power generation block 34 is vertically provided with a threaded cavity 75, and internal threads are formed inside the threaded cavity 75. The right adjustable motor 33 is fixedly installed on the outer side of the lower arm 31 of the right calf by a screw, and the right adjustable motor 33 is electrically connected to the control center 12. External threads are formed on an output shaft of the right adjustable motor 33, and an output shaft of the right adjustable motor 33 is fitted with the threaded cavity 75 at the upper end of the right power generation block 34 to form a screw-thread pair, such that the right adjustable motor 33 can achieve up-down movement and positioning of the right power generation block 34. An encoder and a brake are integrated inside the right adjustable motor 33. The encoder can be configured to monitor a rotating angle of the output shaft in real time, such that a position of the right power generation block 34 has been determined. The brake can achieve stable locking of the output shaft, such that position locking of the right power generation block 34 has been achieved.

A rectangular cavity is formed inside the right power generation block 34, and two round holes are formed in a lower end of the rectangular cavity. The upper copper plate 72 is installed on an upper end in the rectangular cavity, the upper copper plate 72 is connected to a lower end of an upper cable 73, and an upper end of the upper cable 73 is electrically connected to the battery pack 11. The right piezoelectric ceramic 71 is installed on a lower side of the upper copper plate 72, and the right piezoelectric ceramic 71 can generate pulse voltages at its upper and lower ends under pressure. The lower copper plate 70 is installed on a lower side of the right piezoelectric ceramic 71, and the lower copper plate 70 is connected to a lower end of a lower cable 76, and an upper end of the lower cable 76 is electrically connected to the battery pack 11. A damping block 77 is installed on a lower side of the lower copper plate 70, and the damping block 77 may be made of hard rubber to alleviate the impact on the ground when walking. An upper end of the right pressure member 35 is provided with a flat plate structure, the flat plate structure is located at a lower side of the damping block 77, and a lower side of the flat plate structure is provided with two smooth round rods, and the two smooth round rods can pass through the two round holes at the lower end of the rectangular cavity. Two springs 78 are installed between the flat plate structure and the bottom of the rectangular cavity, such that when the user lifts right foot, the right pressure member 35 cannot move downward under the action of gravity. Each of the lower ends of the two smooth round rods is provided with a semicircular block, and the semicircular block is rotatably connected to an upper end of the right foot plate 36. A left side of the right foot plate 36 is provided with a pedal structure, and an upper side of the pedal structure is provided with the right pressure sensor 37. The right pressure sensor 37 is located at a lower side of right foot root of the user, and the right pressure sensor 37 is configured to monitor the pressure between the right foot and the ground in real time and transmit the data to the control center 12 for analysis.

As shown in FIG. 2, the left leg mechanism 2 and the right leg mechanism 1 form a bilateral symmetric structure. The left leg mechanism 2 mainly includes a left rotating seat, a left spring rod 53, an upper arm 38 of a left thigh, a left upper pressure block, a left upper locking screw, an upper strap 39 of a left leg, a lower arm 40 of the left thigh, a left rotating motor 41, a left elastic plate 42, a left support rod 43, an upper arm 44 of a left calf, a left lower pressure block, a left lower locking screw, a lower strap 45 of the left leg, a left adjustable motor 46, a lower arm 47 of left calf, a left power generation block 48, a mushroom head 49, a left pressure member 50, a left foot plate 51, and a left pressure sensor 52. A right side of the left rotating seat is installed on a left end of the hip frame 5 to form a revolute pair, and a rotating shaft is located on an outer side of a left hip joint. An upper end of the upper arm 38 of the left thigh is rotatably connected to a lower end of the left rotating seat, a pressure spring and a damper are integrated into the left spring rod 53, an upper end of the left spring rod 53 is rotatably connected to an upper end of the left rotating seat, and a lower end of the left spring rod 53 is rotatably connected to the upper arm 38 of the left thigh at a position adjacent to an upper end of the upper arm 38 of the left thigh, such that the left spring rod 53 can provide a support force to improve the stability of the exoskeleton system when the upper arm 38 of the left thigh swings towards left. The upper strap 39 of the left leg is arranged on an inner side of a lower end of the upper arm 38 of the left thigh, the upper strap 39 of the left leg is a flexible belt structure with an adjustable length, and can achieve rapid locking and unlocking through a socket-plug structure. The upper strap 39 of the left leg is bound at the left thigh of the user. An outer toothed plate is vertically arranged on an outer side of the lower end of the upper arm 38 of the left thigh, two guide blocks are vertically formed in the middle position of the outer toothed plate, and a threaded hole is formed in a center position of each of the two guide blocks.

The lower arm 40 of the left thigh is of a platy structure, the lower arm 40 of the left thigh is vertically provided with a square guide slot which runs through from left to right at an upper end, and an inner toothed plate is vertically arranged on a left side of the upper end of the lower arm 40 of the left thigh. The lower arm 40 of the left thigh is installed on an outer side of the upper arm 38 of the left thigh, the outer toothed plate is meshed with the inner toothed plate on the outer side of the upper arm 38 of the left thigh, and the two guide blocks on the outer side of the upper arm 38 of the left thigh are located in a square groove at the upper end of the lower arm 40 of the left thigh. The left upper pressure block is of a square platy structure, and a round hole is formed at a center of the left upper pressure block. The two left upper pressure blocks are installed on an outer side of the square guide slot at the upper end of the lower arm 40 of the left thigh, and the two left upper locking screws are fitted with threaded holes at the centers of the corresponding guide blocks after passing through the two left upper pressure blocks, respectively, such that the locking and fixation of the upper arm 38 of the left thigh and the lower arm 40 of the left thigh can be achieved by tightening the two left upper locking screws. After unscrewing the two left upper locking screws, the relative positions of the upper arm 38 of the left thigh and the lower arm 40 of the left thigh can be adjusted according to the bone length of the left thigh of the user. One left rotating motor 41 is fixedly installed at a position adjacent to a lower end of the lower arm 40 of the left thigh. The left rotating motor 41 employs a form of a direct drive motor. A torque sensor and an encoder are integrated inside the left rotating motor 41. The torque sensor is configured to monitor an output torque of the left rotating motor 41 in real time, and the encoder is configured to detect a rotating angle of an output shaft of the left rotating motor 41 in real time, so as to determine a bending condition of a left knee joint of the user. The left rotating motor 41 is electrically connected to the control center 12.

As shown in FIG. 2, the upper arm 40 of the left calf is of a platy structure, an upper end of the upper arm 44 of the left calf is rotatably connected to a lower end of the lower arm 40 of the left thigh, and a rotating shaft is located at an outer side of the left knee of the user. An outer toothed plate is vertically arranged on a left side of a lower end of the upper arm 44 of the left calf, two guide blocks are vertically formed in a middle position of the outer toothed plate, and a threaded hole is formed in a center position of each of the two guide blocks. The lower strap 45 of the left leg is arranged on an inner side of the lower end of the upper arm 44 of the left calf, The lower strap 45 is a flexible strap structure with an adjustable length, and can achieve rapid locking and unlocking through a socket-plug structure. The lower strap 45 of the left leg is bound to the left calf of the user. An output shaft of the left rotating motor 41 is coaxially fastened to a fixed hoop, and the fixed hoop is fastened to a front end of the left elastic plate 42 by a screw. The left elastic plate 42 can be made of an elastic glass fiber material, a rear end of the left elastic plate 42 is fixedly connected to a rotatable hoop by a screw, and the rotatable hoop is rotatably connected to an upper end of the left support rod 43. A lower end of the left support rod 43 is rotatably connected to the upper arm 44 of the left calf at a position adjacent to the upper end of the upper arm 44 of the left calf, and the left support rod 43 can be made of a carbon fiber material. When the user squats, stands up, takes off, walks, etc., the left rotating motor 41 applies a rotational torque to the upper arm 44 of the left calf through the left elastic plate 42 and the left support rod 43, thereby the pressure on the muscle group of the left knee joint of the user is relieved.

The lower arm 47 of the left calf is of a platy structure, a lower end of the lower arm 47 of the left calf deviates backward to a heel position, an upper end of the lower arm 47 of the left calf is vertically provided with a square guide slot which runs through from left to right, and an inner toothed plate is vertically arranged on a right side of the upper end of the lower arm 47 of the left calf. The lower arm 47 of the left calf is installed on an outer side the upper arm 44 of the left calf, the inner toothed plate is meshed with the outer toothed plate on the lower end of the upper arm 44 of the left calf, and the two guide blocks on the outer side of the upper arm 44 of the left calf are in the square slot at the upper end of the lower arm 47 of the left calf. A structure of the left lower pressure block is the same as that of the left upper pressure block. Two left lower pressure blocks are installed on the outer side of the square guide slot at the upper end of the lower arm 47 of the left calf, respectively, two left lower locking screws are fitted with threaded holes formed in the centers of the corresponding guide blocks after passing through the two left lower pressure blocks, respectively, such that the locking and fixation of the upper arm 44 of the left calf and the lower arm 47 of the left calf can be achieved by tightening the two left lower locking screws. After unscrewing the two left lower locking screws, the relative positions of the upper arm 44 of the left calf and the lower arm 47 of the left calf can be adjusted according to the bone length of the left calf of the user. Four guide slot holes are formed in a lower end of the lower arm 47 of the left calf, and each guide slot hole is a vertically arranged strip-shaped through hole.

As shown in FIG. 2 and FIG. 4, the left power generation block 48 is installed on an outer side of the lower end of the lower arm 47 of the left calf, four mushroom heads 49 are arranged on a right side of the left power generation block 48, and each mushroom head 49 is a stepped round rod structure with a larger outer diameter and a smaller inner diameter. The four mushroom heads 49 are fitted with the four guide slot holes at the lower end of the lower arm 47 of the left calf, respectively, such that the left power generation block 48 can move up and down. An upper end of the left power generation block 48 is vertically provided with a threaded cavity, and internal threads are formed inside the threaded cavity. The left adjustable motor 46 is fixedly installed on the outer side of the lower arm 47 of the left calf by a screw, and the left adjustable motor 46 is electrically connected to the control center 12. External threads are formed on an output shaft of the left adjustable motor 46, and the output shaft of the left adjustable motor 46 is fitted with the threaded cavity at the upper end of the left power generation block 48 to form a screw-thread pair, such that the left adjustable motor 46 can achieve up-down movement and positioning of the left power generation block 48. An encoder and a brake are integrated inside the left adjustable motor 46. The encoder can be configured to monitor a rotating angle of the output shaft in real time, such that a position of the left power generation block 48 has been determined. The brake can achieve stable locking of the output shaft, such that position locking of the left power generation block 48 has been achieved.

A rectangular cavity is formed inside the left power generation block 48, and two round holes are formed in a lower end of the rectangular cavity. An upper copper plate is installed on an upper end in the rectangular cavity, the upper copper plate is connected to a lower end of an upper cable, and an upper end of the upper cable is electrically connected to the battery pack 11. A left piezoelectric ceramic is installed on a lower side of the upper copper plate, and the left piezoelectric ceramic can generate pulse voltages at its upper and lower ends under pressure. The lower copper plate is installed on a lower side of the left piezoelectric ceramic, and the lower copper plate is connected to a lower end of a lower cable, and an upper end of the lower cable is electrically connected to the battery pack 11. A damping block is installed on a lower side of the lower copper plate 70, and the damping block 77 may be made of hard rubber to alleviate the impact on the ground when walking. An upper end of the left pressure member 50 is provided with a flat plate structure, the flat plate structure is located at a lower side of the damping block, and a lower side of the flat plate structure is provided with two smooth round rods, and the two smooth round rods can pass through the two round holes at the lower end of the rectangular cavity in the left power generation block 48. Two springs are installed between the flat plate structure and the bottom of the rectangular cavity, such that when the user lifts left foot, the left pressure member 50 cannot move downward under the action of gravity. Each of the lower ends of the two smooth round rods is provided with a semicircular block, and the semicircular block is rotatably connected to an upper end of the left foot plate 51. A right side of the left foot plate 51 is provided with a pedal structure, and an upper side of the pedal structure is provided with the left pressure sensor 52. The left pressure sensor 52 is located at a lower side of left foot root of the user, and the left pressure sensor 52 is configured to monitor the pressure between the left foot and the ground in real time and transmit the data to the control center 12 for analysis.

When the right foot plate 36 is in contact with the ground, the damping block 77 is pressed upwards by the right foot plate 36 through the right pressure member 35, then the damping block 77 applies the pressure to the right piezoelectric ceramic 71 through the lower copper plate 70, and then pulse voltages are generated on the upper end and the lower end of the right piezoelectric ceramic 71, thus a pulse potential difference between the upper copper plate 72 and the lower copper plate 70 is generated. The pulse potential difference is transmitted to the battery pack 11 through the upper cable 73 and the lower cable 76 to achieve pulse charging of the battery pack 11. When the left foot plate 51 is in contact with the ground, the damping block in the left power generation block 48 is pressed upwards by the left foot plate 51 through the left pressure member 50, then the damping block applies the pressure to the left piezoelectric ceramic through the lower copper plate at the upper side thereof, and then pulse voltages are generated on the upper end and the lower end of the left piezoelectric ceramic, thus a pulse potential difference between the upper copper plate and the lower copper plate in the left power generation block 48 is generated. The pulse potential difference is transmitted to the battery pack 11 through the upper cable and the lower cable on the left side to achieve pulse charging of the battery pack 11. When the user keeps walking, the left foot plate 51 and the right foot plate 36 are in contact the ground alternately, thus continuously charging the battery pack 11.

When the user wears the exoskeleton system, threshold values are set for the left pressure sensor 52 and the right pressure sensor 37 in the control center 12. If a pressure value monitored by the left pressure sensor 52 is greater than the set threshold value during the walking of the user, the left adjustable motor 46 rotates to move the left power generation block 48 downward, thereby increasing the pressure borne by the left leg mechanism 2 and further reducing the pressure on the left leg of the user. If the pressure value monitored by the left pressure sensor 52 is less than the set threshold value, the left adjustable motor 46 rotates reversely to move the left power generation block 48 upward, thereby appropriately increasing the pressure on the left foot of the user, which is beneficial for the user to keep body balance. If the pressure value monitored by the right pressure sensor 37 is greater than the set threshold during the walking of the user, the right adjustable motor 33 rotates to move the right power generation block 34 downward, thereby increasing the pressure borne by the right leg mechanism 1 and further reducing the pressure on the right leg of the user. If the pressure value monitored by the right pressure sensor 37 is less than the set threshold value, the right adjustable motor 33 rotates reversely to move the right power generation block 34 upward, thereby appropriately increasing the pressure on the right foot of the user, which is beneficial for the user to keep the body balance. A negative feedback closed-loop control mode is adopted in the above process of adjusting the pressure of the left and right feet.

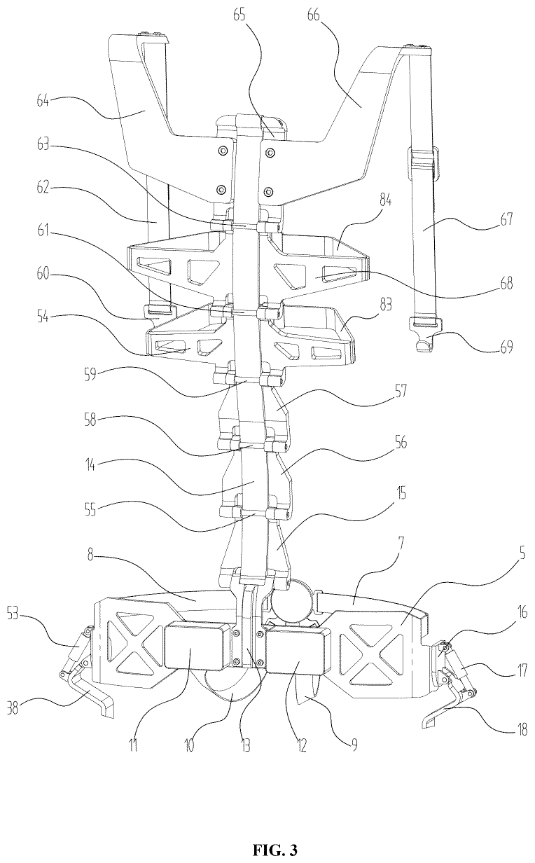

As shown in FIG. 3, the upper body mechanism 4 mainly includes a connecting frame 13, a holding plate 14, a first section 15, a second section 56, a third section 57, a fourth section 54, a fifth section 68, a sixth section 65, a left hanger 64, a right hanger 66, a left hanging strap 62, a right hanging strap 67, a left hook 60, and a right hook 69. A lower end of the connecting frame 13 is fixedly installed at a middle position of a rear side of the hip frame 5 by a screw. The holding plate 14 is of a curved plate structure, and a bending degree of the holding plate 14 is the same as a physiological curve of human spine. The holding plate 14 may be made of an elastic glass fiber material, and a lower end of the holding plate 14 is rotatably connected to an upper end of the connecting frame 13. A lower end of the first section 15 is rotatably connected to the upper end of the connecting frame 13, and the first section 15 is located on a front side of the holding plate 14. A lower end of the second section 56 is rotatably connected to an upper end of the first section 15 by a first shaft 55, the second section 56 is located on the front side of the holding plate 14, and the first shaft 55 is located on a rear side of the holding plate 14 and in contact with the holding plate 14. A lower end of the third section 57 is rotatably connected to an upper end of the second section 56 by a second shaft 58, the third section 57 is located on the front side of the holding plate 14, and the second shaft 58 is located on the rear side of the holding plate 14 and in contact with the holding plate 14. A lower end of the fourth section 54 is rotatably connected to an upper end of the third section 57 through a third shaft 59, the fourth section 54 is located on the front side of the holding plate 14, and the third shaft 59 is located on the rear side of the holding plate 14 and in contact with the holding plate 14. Lengthening plates are arranged on the left and right sides of the fourth section 54, the lengthening plates can increase the contact area between the fourth section 54 and the back of the user. A rear end of a lower chest strap 83 is fixedly connected to the lengthening plates on both sides of the fourth section 54, and the lower chest strap 83 is of a flexible band structure with adjustable length, and can achieve rapid locking and unlocking through a socket-plug structure. The lower chest strap 83 is bound to a position between the seventh pair of ribs and the ninth pair of ribs of the user. A lower end of the fifth section 68 is rotatably connected to an upper end of the fourth section 54 by a fourth shaft 61, the fifth section 68 is located on the front side of the holding plate 14, and the fourth shaft 61 is located on the rear side of the holding plate 14 and in contact with the holding plate 14. Lengthening plates are arranged on the left and right sides of the fifth section 68, the lengthening plates can increase the contact area between the fifth section 68 and the back of the user. A rear end of an upper chest strap 84 is fixedly connected to the lengthening plates on both sides of the fifth section 68, and the upper chest strap 84 is of a flexible band structure with adjustable length, and can achieve rapid locking and unlocking through a socket-plug structure. The upper chest strap 84 is bound to a position between the third pair of ribs and the fifth pair of ribs of the user. A lower end of the sixth section 65 is rotatably connected to an upper end of the fifth section 68 by a fifth shaft 63, the sixth section 65 is located on the front side of the holding plate 14, the fifth shaft 63 is located on the rear side of the holding plate 14 and in contact with the holding plate 14. An upper end of the sixth section 65 is rotatably connected to an upper end of the holding plate 14 by a pin shaft.

A lower end of the left hanger 64 is fixedly connected to a left side of the sixth section 65 by a screw, an upper end of the left hanger 64 extends upwards and then extends forwards to across an upper side of the left shoulder of the user, a front end of the left hanger 64 is fixedly connected to an upper end of the left hanging strap 62, the left hanging strap 62 is a flexible belt structure with an adjustable length, and a lower end of the left hanging strap 62 is connected to the left hook 60. A lower end of the right hanger 66 is fixedly connected to a right side of the sixth section 65 by a screw, an upper end of the right hanger 66 extends upwards and then extends forwards to across an upper side of the right shoulder of the user. A front end of the right hanger 66 is fixedly connected to an upper end of the right hanging strap 67, the right hanging strap 67 is a flexible belt structure with an adjustable length, and a lower end of the right hanging strap 67 is connected to the right hook 69.

When the user bends down to lift a heavy object, firstly, when the user bends their waist, the first shaft 55, the second shaft 58, the third shaft 59, the fourth shaft 61 and the fifth shaft 63 can drive the holding plate 14 to bend adaptively with the spine of the user, in this case, the holding plate 14 is elastically deformed, and elasticity of the holding plate 14 can relieve the pressure on erector spinae group of the user, which is helpful for the user to restore the upright posture. Afterwards, the left hook 60 and the right hook 69 are hooked on the left and right sides of the heavy object, respectively, and the user can hold the heavy object with both hands to keep the balance of the heavy object.

When the user walks with the heavy object, the gravity of the heavy object is mainly transmitted to the sixth section 65 through the left hanging strap 62 and the right hanging strap 67, then the pressure is transmitted by the sixth section 65 to the hip frame 5 through the holding plate 14 and the connecting frame 13, afterwards, the pressure is transmitted by the hip frame 5 to the ground through the left leg mechanism 2 and the right leg mechanism 1, thus reducing the pressure on the body when the user carries the heavy object is relieved.

What is claimed is:

1. An exoskeleton system, mainly comprising a right leg mechanism, a left leg mechanism, a hip frame mechanism, and an upper body mechanism, wherein,
the hip frame mechanism mainly comprises a hip frame, a battery pack, a control center, a left hip strap, a right hip strap, a multi-port buckle, a right buttock strap and a left buttock strap, wherein the battery pack and the control center are installed on a rear side of the hip frame, the multi-port buckle is provided with four insertion holes, and is provided with an unlock button at a center position of a front side; rear ends of the right hip strap, the left hip strap, the right buttock strap and the left buttock strap are connected to the hip frame, and front ends of the right hip strap, the left hip strap, the right buttock strap and the left buttock strap are locked to the multi-port buckle by plugs;
the right leg mechanism mainly comprises a right rotating seat, a right spring rod, an upper arm of a right thigh, an upper strap of a right leg, a lower arm of the right thigh, a right rotating motor, a right elastic plate, a right support rod, an upper arm of a right calf, a lower arm of the right calf, a lower strap of the right leg, a right adjustable motor, a right power generation block, a right pressure member, a right foot plate, a right pressure sensor, a lower copper plate, a right piezoelectric ceramic, and an upper copper plate, wherein the right rotating seat is installed on a right end of the hip frame to form a revolute pair, an upper end of the upper arm of the right thigh is rotatably connected to a lower end of the right rotating seat, the right spring rod is installed between the right rotating seat and the upper arm of the right thigh, and the upper strap of the right leg is arranged on an inner side of a lower end of the upper arm of the right thigh; the lower arm of the right thigh is installed on an outer side of the upper arm of the right thigh through the meshing of toothed plates and by screw locking, and one right rotating motor is installed at a position adjacent to a lower end of the lower arm of the right thigh; an upper end of the upper arm of the right calf is rotatably connected to a lower end of the lower arm of the right thigh, the lower strap of the right leg is arranged on an inner side of a lower end of the upper arm of the right calf, an output shaft of the right rotating motor is fastened to a front end of the right elastic plate, a rear end of the right elastic plate is rotatably connected to an upper end of the right support rod, and a lower end of the right support rod is rotatably connected to the upper arm of the right calf at a position adjacent to the upper end of the upper arm of the right calf; the lower arm of the right calf is installed on an outer side of the upper arm of the right calf through the meshing of toothed plates and by screw locking; the right power generation block is installed on an outer side of the lower arm of the right calf and capable of moving up and down, the right adjustable motor is fixedly installed on the outer side of the lower arm of the right calf, external threads are formed on an output shaft of the right adjustable motor, and the threaded output shaft is fitted with a threaded cavity at an upper end of the right power generation block to form a screw-thread pair; the right power generation block is internally provided with a rectangular cavity; the upper copper plate, the right piezoelectric ceramic, the lower copper plate, a damping block and the right pressure member are sequentially installed in the rectangular cavity from top to bottom; the upper copper plate and the lower copper plate are electrically connected to the battery pack by two cables, respectively; a lower end of the right pressure member is rotatably connected to an upper end of the right foot plate, the right pressure sensor is installed on an upper side of a pedal structure on a left side of the right foot plate, and the left leg mechanism and the right leg mechanism form a bilateral symmetric structure;
the upper body mechanism mainly comprises a connecting frame, a holding plate, a first section, a second section, a third section, a fourth section, a fifth section, a sixth section, a left hanger, a right hanger, a left hanging strap, a right hanging strap, a left hook, and a right hook; wherein a lower end of the connecting frame is fixedly installed at a middle position of a rear side of the hip frame; the holding plate is of a curved plate structure, a lower end of the holding plate and a lower end of the first section are rotatably connected to an upper end of the connecting frame; the first section, the second section, the third section, the fourth section, the fifth section and the sixth section are installed on a front side of the holding plate, and sequentially connected end to end through five rotating shafts from bottom to top, and the five rotating shafts are located on a rear side of the holding plate; an upper end of the sixth section is connected to an upper end of the holding plate by a pin shaft; lengthening plates are arranged on left and right sides of the fourth section and the fifth section; a lower chest strap is installed at left and right ends of the fourth section, and an upper chest strap is installed at left and right ends of the fifth section; a lower end of the left hanger is fixedly connected to a left side of the sixth section, and an upper end of the left hanger is connected to the left hook through the left hanging strap after crossing a left shoulder of a user forward; a lower end of the right hanger is fixedly connected to a right side of the sixth section, and an upper end of the right hanger is connected to the right hook through the right hanging strap after crossing a right shoulder of the user forward.

2. The exoskeleton system according to claim 1, wherein the battery pack is able to be charged and discharged, and provide electric energy for all electrical devices of the exoskeleton system; a central processing unit and an integrated circuit are integrated into the control center, and the control center is configured to automatically control electric components in the exoskeleton system based on pre-set parameters.

3. The exoskeleton system according to claim 1, wherein each of the upper strap of the right leg, the lower strap of the right leg, the upper strap of the left leg and the lower strap of the left leg is a flexible belt structure with an adjustable length, and is able to be rapidly locked and unlocked through a socket-plug structure.

4. The exoskeleton system according to claim 1, wherein the right rotating motor employs a form of a direct drive motor, and the direct drive motor has the advantages of large low-speed torque, simple structure and low noise; a torque sensor and an encoder are integrated inside the right rotating motor; the torque sensor is configured to monitor an output torque of the right rotating motor in real time, and the encoder is configured to detect a rotating angle of an output shaft of the right rotating motor in real time, so as to determine a bending condition of a right knee joint of the user.

5. The exoskeleton system according to claim 1, wherein the right elastic plate is made of an elastic glass fiber material, which has excellent mechanical properties, and the characteristics of light weight, high strength, high and low temperature resistance and corrosion resistance.

6. The exoskeleton system according to claim 1, wherein after the right piezoelectric ceramic is pressed, pulse voltages are generated at an upper end and a lower end of the right piezoelectric ceramic, thus a pulse potential difference between the upper copper plate and the lower copper plate is generated; and the pulse potential difference is transmitted into the battery pack through a cable for pulse charging.

7. The exoskeleton system according to claim 1, wherein the right pressure sensor is configured to monitor a pressure between the right leg and the ground in real time, and transmit data to the control center for analysis.

8. The exoskeleton system according to claim 1, wherein the bending degree of the holding plate is the same as a physiological curve of human spine, and the holding plate is made of an elastic glass fiber material.

9. The exoskeleton system according to claim 1, wherein each of the lower chest strap and the upper chest strap is a flexible belt structure with an adjustable length, and is able to be rapidly locked and unlocked through a socket-plug structure.

10. The exoskeleton system according to claim 1, wherein each of the left hanging strap and the right hanging strap is a flexible belt structure with an adjustable length.
